(19) United States
(12) Patent Application Publication
(10) Pub. No.: US 2015/0379456 A1
(43) Pub. Date: Dec. 31, 2015

(54) SYSTEMS AND TECHNIQUES FOR ENSURING THE INTEGRITY OF ENTERPRISE ASSET MANAGEMENT DATA

(71) Applicant: Utopia Global, Inc., Mundelein, IL (US)

(72) Inventors: Peter Norman Aynsley-Hartwell, Dubai (AE); William Joseph Meinweiser, Lafayette, IN (US)

(21) Appl. No.: 14/752,360

(22) Filed: Jun. 26, 2015

Related U.S. Application Data
(60) Provisional application No. 62/018,987, filed on Jun. 30, 2014.

(51) Int. Cl. G06Q 10/06; G06F 17/30

(52) U.S. Cl. CPC G06Q 10/063114; G06F 17/30342

(57) ABSTRACT

Systems and techniques are described for ensuring the integrity of enterprise asset management data stored in a database system. Systems include an enterprise asset management data store with enterprise asset management data entities of one or more entity type. Entity types include an equipment entity type, a functional location entity type, an MRO bill of material entity type, and a work center entity type. Each entity type includes attributes and specific update validation rules. Techniques are further provided for directing update requests for changes to enterprise asset management data entities thorough a series of work queues, each of which may operate to enforce the specific update validation rules apropos to the enterprise asset management data entities being changed.

CROSS-REFERENCE TO A RELATED APPLICATION

This application claims the benefit of U.S. Provisional Application Ser. No. 62/018,987, filed Jun. 30, 2014, which is hereby incorporated by reference in its entirety, including any figures, tables, or drawings.

### BACKGROUND

An important objective for enterprises is to maintain an accurate and up-to-date version of master data, given that the master data supports the operational and analytical sides of an enterprise. In order to create and maintain master data, it is desirable to ensure the integrity of data received from the various operational and analytical systems. However, master data quality issues may arise due to incomplete and/or erroneous information within data received from the various operational and analytical systems. These data quality issues can multiply as the number of operational and analytical systems in an enterprise is increased.

One way to address data quality issues is by using data governance tools to ensure proper handling of data records. Data governance tools are used to monitor data quality at each operational and analytical system and at a master data hub. An enterprise can make use of data governance tools at each system and hub, but this can lead to compartmentalization. Such use of separate tools at each system and hub fails to provide a streamlined process by which data is governed (i.e., received, handled, processed, evaluated, corrected, and made viewable) throughout all systems and hubs of an enterprise.

Enterprise resource planning systems, such as SAP® (from SAP AG), are integrated enterprise software solutions. SAP Master Data Governance (MDG) is a process-centric application that provides centralized governance for selected master data domains based on SAP's standard data models. MDG supports central maintenance processes that ensure that the master data is fit for use in SAP Business Suite processes. MDG provides out-of-the-box data models, validations, user interfaces, and workflow, and in addition also allows for customized processes in order to ensure a consistent definition and governance of master data in the organization. This, together with the distribution of the master data, can replace the often error-prone process of manually maintaining master data in multiple systems. SAP MDG provides the flexibility to extend the delivered models or to build completely new MDG applications with appropriate workflows, roles, user interfaces and validation.

### SUMMARY

Systems and techniques are described for ensuring the integrity of enterprise asset management data stored in a database system. Embodiments include an enterprise asset management data store with enterprise asset management data entities of one or more entity type. Entity types include an equipment entity type, a functional location entity type, an MRO bill of material entity type, and a work center entity type. Each entity type includes attributes and specific update validation rules.

Embodiments include techniques for directing update requests for changes to enterprise asset management data entities thorough a series of work queues, each of which may operate to enforce the specific update validation rules apropos to the enterprise asset management data entities being changed. Changes to enterprise asset management data entities may be stored in a temporary repository before being committed to the master enterprise asset management data store.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 shows an example component environment in which techniques and systems of the subject invention may be practiced.

FIG. 2 shows an example workflow for ensuring the integrity of enterprise asset management data in accordance with the subject invention.

FIG. 3 shows an example process flow for ensuring the integrity of enterprise asset management data.

FIG. 4 shows a block diagram illustrating components of a computing device or system used in some implementations.

FIG. 5 illustrates an example system architecture in which an implementation of techniques and systems for ensuring the integrity of enterprise asset management data may be carried out.

### DETAILED DESCRIPTION

Systems and techniques are described for ensuring the integrity of enterprise asset management data stored in a database system. Technical features of the subject invention produce advantageous technical effects in the operation of data systems. Systems and techniques operate to improve the integrity of enterprise asset management data stored within a data store and/or database system, which may improve database system reliability, performance, and data integrity within operational and analytic systems reliant upon the enterprise asset management data.

Some embodiments include an enterprise asset management data store with enterprise asset management data entities of one or more entity type. Entity types include an equipment entity type, a functional location entity type, an MRO bill of material entity type, and a work center entity type. Each entity type includes attributes and specific update validation rules. Entity types may support the operation of “plants,” which may be broadly defined to include, for example, airports, steel mills, hospitals, mines, ship yards, large buildings, hotels, chemical plants, cement plants, subway systems, railway systems, container terminals, oil drilling rigs or platforms, paper mills, oil or natural gas pipeline systems, lime plants, water treatment plants including desalination, fresh water pipelining and waste water treatment, food service facilities, etc. Enterprise asset management data entity types may be particularly well-suited to linear asset intensive industries such as electricity generation and transmission, railway, and oil/gas pipeline.

Embodiments include techniques for directing update requests for changes to enterprise asset management data entities thorough a series of work queues, each of which may operate to enforce the specific update validation rules apropos to the enterprise asset management data entities being changed. Changes to enterprise asset management data entities may be stored in a temporary repository before being committed to the master enterprise asset management data store.

Some embodiments may enhance an existing master data governance system, such as the SAP® MDG system. In embodiments integrating with an existing master data governance system, the subject invention includes process flows and enterprise asset management entities including attributes and specific update validation rules.

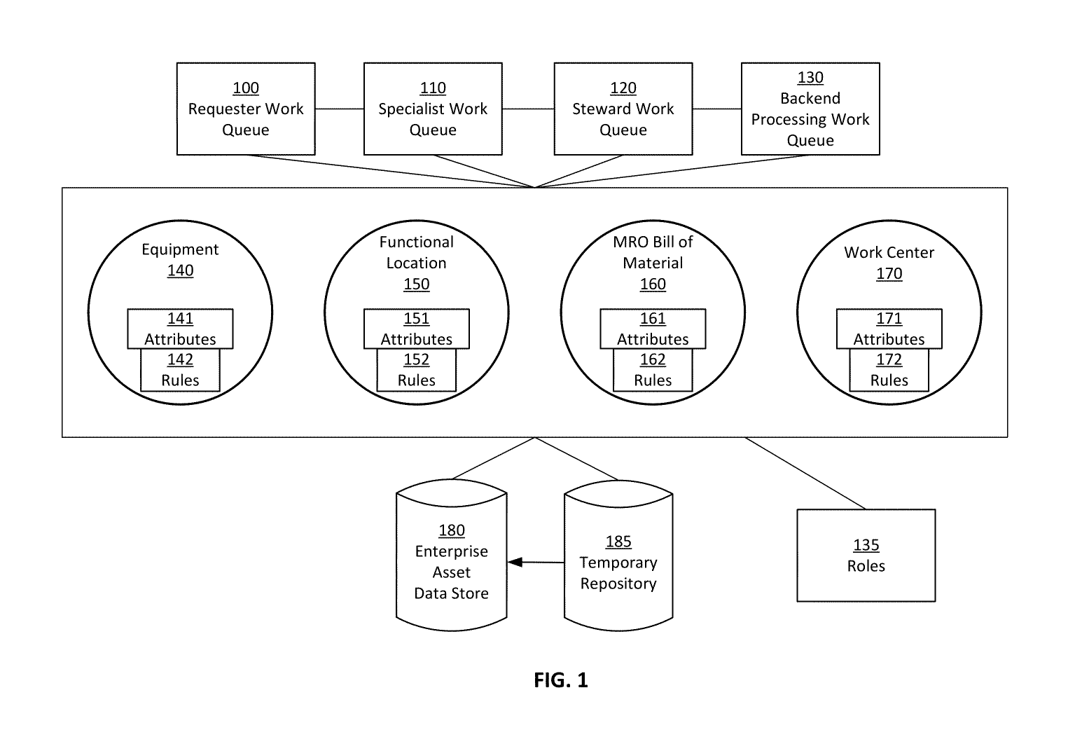

FIG. 1 shows an example component environment in which techniques and systems of the subject invention may be practiced. FIG. 1 shows queues (100, 110, 120, 130), which may be assigned security roles 135, entity types with entities (140, 150, 160, 170) stored on an enterprise asset data store 180, and a temporary repository 185 for storing requested changes until approved.

A work queue, generally, is a holding place in a workflow process where requests await further processing, approval, and/or rejection. A work queue may be accessed by a user interface of an application, and the data or metadata required for storing a request's position in the workflow (e.g., presence in a work queue) can be stored in a separate data store.

Work queues described herein are of four types, requester 100, specialist 110, steward 120, and backend processing 130. Each work queue represents a holding point where a request to update enterprise asset data may undergo review, approval, rejection, return to a prior queue, and/or final backend processing. A work queue of a particular type has a “role” associated with the queue that defines the behaviors the work queue can perform. Security logins associated with individual users/groups control access to the user interface of the queue, allowing users to access the queue and perform the role's behaviors by virtue of their being members of the role that attaches to the queue. For example, user “John” may access the requester work queue user interface by having the role “requester” associated with his user login credentials. Data or metadata associated with the role may be stored in a component 135, which may include a data store.

A requester queue 100 having a requester role has the security attributes to request a change to enterprise asset management data, but not to approve and enact the change. A requester role is deployed to users who request new enterprise asset data or updates to existing enterprise asset data.

A specialist queue 110 having a specialist role has the security attributes to, for example, approve an update request, modify the data elements that are part of the update request, or return the request to the requester for further processing. The specialist role is deployed to users who have in-depth knowledge of the enterprise asset management data entities placed under governance. More than one specialist queue 110 may exist in a given instance or implementation, as for example when different queues associated with different departments have specific domain knowledge about a subset of the enterprise asset management data.

A steward queue 120 having a steward role has the security attributes to, for example, approve an update request so that the change request stored in the temporary data repository 185 can be enacted in the enterprise asset data store 180, or return the request to a prior queue for further processing. The steward role is deployed to users who have custodial responsibility for the enterprise asset management data entities placed under governance. More than one steward queue 120 may exist in a given instance or implementation, as for example when different queues associated with different departments have specific data stewardship over a subset of the enterprise asset management data.

A backend processing work queue 130 having a backend processing role has the security attributes to update the enterprise asset data store 180 with the pending change request in the temporary data repository 185.

Techniques and systems ensure the integrity of enterprise asset management data stored with respect to certain entity types. Entity types, here, are representations of a physical or conceptual entity useful in the management of enterprise asset management data. Entity types described herein include an equipment entity type, functional location entity type, MRO bill of material entity type, and a work center entity type.

An entity type describes the attributes (also known as “properties”) of an entity. The totality of the individual values of the attributes for a specific instance of an entity is sometimes called the entity's “state.” Whereas the entity type describes the overall characteristics of the entity, the values of the attributes, or state, define the entity. In some instances, certain attributes can have a “null” value when the attribute does not pertain to the type of asset.

A definition of an entity type may be housed in an enterprise asset data store 180. A definition of an entity type can be implemented in a variety of ways in an enterprise asset data store. For example, an entity type can be implemented as a database table in a relational database. Each column of the table can describe an attribute of the entity. Each row of the table represents a specific instance of the entity; the intersection of the attribute (column) and the entity (row) defines a cell in which the specific value of a specific attribute for that entity is stored.

Storage of an entity can also be implemented as Extended Markup Language (XML) elements and attributes in accordance with an XML Schema definition. The XML script may be stored in files stored in a file system. In some cases, an entity type may relate or refer to other entity types that may be stored in other database tables or XML descriptions.

Entity type definitions may be implemented as part of an existing data governance system having additional support entities, workflow processes, or user interface applications. An example of an existing data governance system is SAP MDG®. Other methods of defining an entity type are possible, as a practitioner in the art will recognize.

An entity type may include “rules” (or “update validation rules”) that define restrictions on the modification of the enterprise asset management data encapsulated by that entity type. The rules may define logic that must be enforced before any update request is allowed. Business rules may be individually associated with each entity type to perform activities such as: calculation of costs, overhead, and risks; matching responsibilities, suitable products, and locations; and detection of invalid relationships between data. A rule may be implemented as a set of expressions that are assigned to a function defining the operation of the rule.

In some cases, the rules may define data validation rules pertaining to the type of data entered. For example, a data validation rule may require that data entered into a “price” attribute be entered as a decimal number.

In the case of either business or data validation rules, each type of work queue may have a particular subset of rules pertaining to the role associated with the queue and the entities being changed. An update request may violate no rules, or it may violate one or more rules. A rule that is violated may have one or more behaviors associated with it, including: displaying text or description of the rule in a user interface of an application, displaying a remedial action the role can perform on the update request to remediate the rule violation, and returning the update request to a prior queue.

One kind of enterprise asset management data entity is an “equipment entity” 140. A particular equipment entity 140 describes a single physical object that is maintained as an autonomous unit. Examples include point-oriented objects, line-oriented objects, and area-oriented objects. Point-oriented objects can be, for example, transformers, stations, poles, HV towers, points, valves, lights, signals, and pumps. Line-oriented objects can be, for example, circuits, grids, sections, highways, streets, tracks, systems, and pipes. Area-oriented objects can be, for example, real property such as fields or lots, counties, right-of-ways, dams, and forests.

An enterprise asset management system installed at a particular organization, for example, stores the multiplicity of equipment entities which is under management by the organization. A pipeline company, for example, may own a pipeline reaching from a place in Louisiana to a place in Texas. The pipeline is made up of a multiplicity of segments or sections of pipe. Each section of pipe is a particular instance of an equipment entity of the equipment entity type. Naturally, a pipeline is only a non-limiting example of an equipment entity.

As noted, each entity type has attributes. Table 1A shows an example of the attributes 141 of an equipment entity type used in some embodiments. An embodiment of an equipment entity type 140 can have, for example, attributes 141 specifying an equipment number, an equipment class, asset number, serial number, manufacturer, purchase date, model number, dimensional and weight characteristics, warranty information, last maintenance date, etc. Every instance of an equipment entity 140 has a combination of specific values for each of these attributes 141, e.g., an electric motor manufactured by General Electric, serial number P374895, purchased on Jan. 1, 1990, model number P1239. However, the attributes in Table 1A are not intended to be limiting as to either attribute name or attribute description.

An embodiment of an equipment entity type 140 can also define rules 142. Table 1B shows an example of rules 142 used in some embodiments. Table 1B shows the rule identifier, description, and message text displayed for each rule. For example, rules 142 can include rules for valid data entry (e.g., a rule that dates have to be in a certain range or format) or that data should have a certain relationship to other data (e.g., that an equipment must be installed at the same functional location at which its maintenance is performed). However, the rules in Table 1B are not intended to be limiting as to rule name, description, or message.

Another kind of enterprise asset management data entity is a “functional location entity” 150. A functional location entity type 150 comprises data describing a place at which a maintenance task is performed; the place can be described according to functional, process-oriented, or spatial criteria. Places defined according to spatial criteria may have various spatial attributes, for example, map coordinates, addresses, GPS locations, or positions within a schematic diagram of a system. Places defined according to functional criteria may delineate a location where a particular function is performed, for example a department, or a work station on a factory floor. Places defined according to process-oriented criteria may describe, for example, a stage in a workflow process or lifecycle. Equipment entities 140 may be located at one or more functional locations described by a functional location entity 150.

Table 2A shows an example of the attributes 151 of a functional location entity type 150 used in some embodiments. An embodiment of a functional location entity type 150 can have, for example, attributes 151 specifying a work center, settlement order, plant section, company code, acquisition date, acquisition value, year of construction, person responsible, etc. However, the attributes in Table 2A are not intended to be limiting as to either attribute name or attribute description.

An embodiment of a functional location entity type 150 can also define rules 152. Table 2B shows an example of rules 152 used in some embodiments. Table 2B shows the rule identifier, description, and message text displayed for each rule. For example, rules 152 can include rules for valid data entry (e.g., that an acquisition value should not be entered without a description) or that data should have a certain relationship to other data (e.g., that values for a plant section attribute should not be entered without a plant identifier). However, the rules in Table 2B are not intended to be limiting as to rule name, description, or message.

Another kind of enterprise asset management data entity is a “MRO Bill of Material” entity 160. An MRO Bill of Material entity type 160 comprises data describing a quantity, a unit of measure, and a description of one or more components that make up a physical object. These components may be known as BOM Items, which may be defined as a separate entity type. An example of a MRO Bill of Material is a parts manifest for repairing an object being maintained. For example, if a MRO Bill of Material entity pertains to a parts list for a pump overhaul that is performed yearly, BOM items that are components of the pump might include a gasket, o-rings, solenoid, a sealant, and replacement nuts and bolts.

Table 3A shows an example of the attributes 161 of an MRO Bill of Material entity type 160 used in some embodiments. An embodiment of an MRO Bill of Material entity type 160 can have, for example, attributes 161 specifying base quantity, base unit of measure, bill of material identifying number, and validity date range. Table 3B shows an example of the attributes of a BOM Item used in some embodiments. A BOM Item entity type can have, for example, attributes specifying the item's price and whether it is maintained as spare parts or must be ordered. However, the attributes in Table 3A and 3B are not intended to be limiting as to either attribute name or attribute description.

An embodiment of an MRO Bill of Material entity type 160 can also define rules 162. Table 3C shows an example of rules 162 used in some embodiments. Table 3C shows the rule identifier, description, and message text displayed for each rule. For example, rules 162 can include rules for valid data entry (e.g., a rule that dates have to be in a certain range or format) or that data should have a certain relationship to other data (e.g., that a material cannot be both “cost relevant” and “bulk material”). However, the rules in Table 3C are not intended to be limiting as to rule name, description, or message.

Another kind of enterprise asset management data entity is a “work center entity” 170. A work center entity type 170 comprises data describing where and when an activity is performed. A work center has an available capacity. The activities performed at or by the work center are valued by charge rates, which are determined by cost centers and activity types. Work centers can be, for example, machines, people, production lines, and groups of craftsmen.

Table 4A shows an example of the attributes 171 of a work center entity type 170 used in some embodiments. An embodiment of a work center entity type 170 can have, for example, attributes specifying a work center identifier, capacity, formula for the duration of processing time, formula for setup time, unit of measure of the work, etc. However, the attributes in Table 4A are not intended to be limiting as to either attribute name or attribute description. An embodiment of a work center entity type 170 can also define rules 172. Table 4B shows an example of rules 172 used in some embodiments. Table 4B shows the rule identifier, description, and message text displayed for each rule. For example, rules 172 can include rules for valid data entry (e.g., a rule that dates have to be in a certain range or format) or that data should have a certain relationship to other data (e.g., that certain capacities are required for certain work center subtypes). However, the rules in Table 4B are not intended to be limiting as to rule name, description, or message.

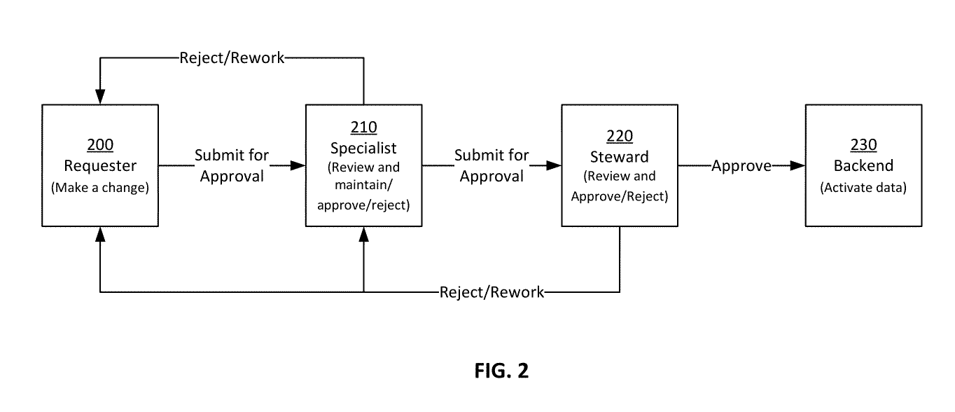

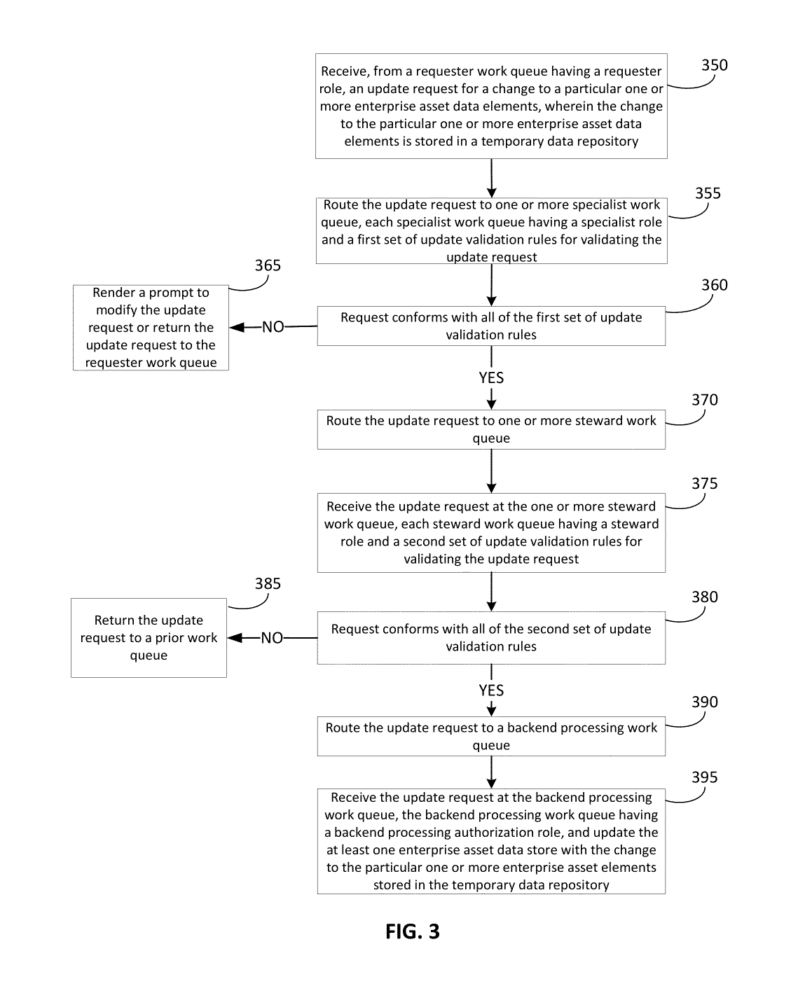

FIG. 2 shows an example workflow for ensuring the integrity of enterprise asset management data in accordance with the subject invention. FIG. 2 shows a basic view of the process flow activities that are explored in greater detail in FIG. 3.

Initially, a requester queue 200, having a requester role which can be associated with a user login, indicates a change in enterprise asset management data relating to an enterprise asset data entity. For example, an employee in the operations management department of a factory might need to modify the model number of a pump installed at the factory. The employee may enter a user interface rendered by an application for managing a requester work queue, search for the pump through the interface, and indicate that an update to a data element is desired via the user interface. The employee makes the change to the pump model number and saves the change, which records the change in a temporary data repository as the change moves through the workflow.

The update request is routed to a specialist queue 210, having a specialist role. A specialist role, in the specific pump example, could be, e.g., a higher level employee in the operations department or a technical supervisor. The specialist reviews the requested change and is notified via the user interface of any update validation rules which were violated. Depending on the validation errors, the specialist can accept the changes, further modify the data, or return the update request to the requester queue for further processing. Though the workflow illustrated in FIG. 2 is simplified to show only one specialist queue, the request could in some instances be routed to multiple specialists, in series or in parallel.

If the change is acceptable, the update request is routed to a steward queue 220. A steward role, in the specific pump example, could be, e.g., a data manager in the information technology department. The steward reviews the requested change and is notified via the user interface of any update validation rules which were violated. Depending on the validation errors, the steward can accept the changes or return the update request to the requester queue or to one or more of the specialist queues for further processing. Though the workflow illustrated in FIG. 2 is simplified to show only one steward queue, the request could in some instances be routed to multiple stewards, in series or in parallel.

If the change is acceptable to the steward queue 220, the update request is routed to a backend processing queue 230. The backend processing queue 230 may be an automated process with the authority to commit the changes stored in the temporary data repository 185 to the enterprise asset data store 180. Depending on the configuration of the enterprise asset data store, activities performed by the backend processing queue 230 for updating the enterprise asset data store with the changes may include replicating the data to multiple operational and analytical data stores.

FIG. 3 shows an example process flow for ensuring the integrity of enterprise asset management data. Processing initiates with the receipt of an update request for a change to one or more enterprise asset management data elements (350). As noted, enterprise asset management entities include equipment entities, functional location entities, MRO bill of material entities, and work center entities. Changes to data elements can include modification to attributes of one or more entity, deletion of one or more entity, or addition of one or more entity.

As described in FIG. 2 and the associated description, the update request is received from a work queue having a requester role. As noted, a requester role has the security attributes to request a change to enterprise asset management data, but not to approve and enact the change. The change is stored in a temporary data repository that may record requested changes while they are being approved and modified. The temporary data repository may contain, for example, a copy of the changed data entities, or a transaction log of the underlying instructions to enact the changes.

An update request contains one or more changes to one or more enterprise asset management data elements. A data element can include a modification to one, or more than one, of the attributes of an entity. For example, the model number of a pump installed in a factory may need to be changed. A data element, in this example, is the value of the model number attribute for that pump, stored in the equipment entity data store. The data elements of an update request can also be attribute changes for more than one entity, including for more than one entity type. The data elements of the update request can also include directives for removal of entities of one or more entity type, and/or the addition of entities of one or more entity type.

The update request is now routed to one or more specialist work queue (355). Each specialist work queue may be assigned a specialist security role identifying the specific individuals who may access a specialist queue. In some cases, the update request may be routed to more than one specialist work queue. The routing may occur in series or in parallel. Multiple different specialist work queues may be responsible for reviewing and approving the changes to different data elements, or may serve as an additional check on the same data.

A workflow pattern may be specially designed using a workflow designer interface to customize the workflow for a given installation of systems and techniques at a particular site. The location of update requests in an overall workflow, the design of a workflow, and other information about a workflow may be stored in a workflow data/metadata store stored on one or more computer readable media of the system.

Each specialist work queue also has an associated first set of update validation rules for validating the update request. Update validation rules are associated with the entity type, as noted with respect to FIG. 1 (142, 152, 162, 172). The set of operative update validation rules may pertain to the data itself, or to the permissions a particular specialist possesses to modify specific data elements. In some cases, a message indicating the details of one or more of the violated update validation rules may be shown in a user interface for managing the queue.

If the request does not conform with all of the first set of update validation rules (360), the update request may be modified or returned to the requester queue for further processing (365). In some cases, a prompt may be rendered that displays information related to the rule violation and/or suggestions for remediation. If the update request conforms with all of the first set of update validation rules, processing continues on the “YES” branch and the update request is routed to one or more steward work queue (370).

The update request is received by one or more steward work queue (375). Each steward work queue may be assigned a steward security role identifying the specific individuals who may access a steward queue. In some cases, the update request may be routed to more than one steward work queue. The routing may occur in series or in parallel. Multiple different steward work queues may be responsible for reviewing and approving the changes to different data elements, or may serve as an additional check on the same data.

Each steward work queue also has an associated second set of update validation rules for validating the update request. Update validation rules are associated with the entity type, as noted with respect to FIG. 1 (142, 152, 162, 172). The update validation rules may pertain to the data itself, or to the permissions a particular steward possesses to modify specific data elements. In some cases, a message indicating the details of one or more of the violated update validation rules may be shown in a user interface for managing the queue.

If the request does not conform with all of the second set of update validation rules (380), the update request may be returned to a prior work queue for further processing (385).

A prior queue can include any of the one or more specialist work queues or the requester work queue. If the update request conforms with all of the second set of update validation rules, processing continues on the “YES” branch and the update request is routed to one or more backend work processing queue (390).

The update request is received at the backend processing work queue (395). The backend processing work queue may be an automated process. The backend processing work queue may be assigned a backend processing authorization role possessing the authority to commit the changes stored in the temporary data repository 185 to the enterprise asset data store 180. Depending on the configuration of the enterprise asset data store, activities performed by the backend processing work queue for updating the enterprise asset data store with the changes may include replicating the data to multiple operational and analytical data stores.

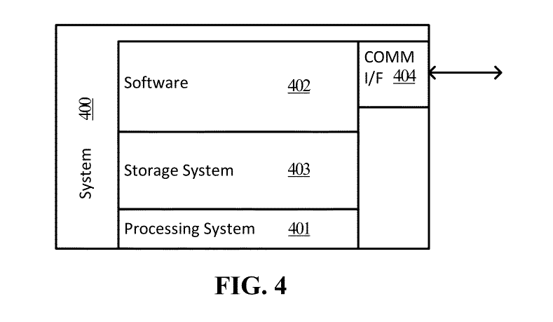

FIG. 4 shows a block diagram illustrating components of a computing device or system used in some implementations. For example, any computing device operative to run an application having a requester work queue 100, specialist work queue 110, steward work queue 120, backend processing work queue 130, enterprise asset management data store 180, or temporary repository 185 (from FIG. 1), or intermediate devices facilitating interaction between other devices in the environment, may each be implemented as described with respect to system 400, which can itself include one or more computing devices. The system 400 can include one or more blade server devices, standalone server devices, personal computers, routers, hubs, switches, bridges, firewall devices, intrusion detection devices, mainframe computers, network-attached storage devices, and other types of computing devices. The server hardware can be configured according to any suitable computer architectures such as a Symmetric Multi-Processing (SMP) architecture or a Non-Uniform Memory Access (NUMA) architecture.

The system 400 can include a processing system 401, which may include a processing device such as a central processing unit (CPU) or microprocessor and other circuitry that retrieves and executes software 402 from storage system 403. Processing system 401 may be implemented within a single processing device but may also be distributed across multiple processing devices or sub-systems that cooperate in executing program instructions.

Examples of processing system 401 include general purpose central processing units, application specific processors, and logic devices, as well as any other type of processing device, combinations, or variations thereof. The one or more processing devices may include multiprocessors or multi-core processors and may operate according to one or more suitable instruction sets including, but not limited to, a Reduced Instruction Set Computing (RISC) instruction set, a Complex Instruction Set Computing (CISC) instruction set, or a combination thereof. In certain embodiments, one or more digital signal processors (DSPs) may be included as part of the computer hardware of the system in place of or in addition to a general purpose CPU.

Storage system 403 may comprise any computer readable storage media readable by processing system 401 and capable of storing software 402. Storage system 403 may include volatile and nonvolatile, removable and non-removable media implemented in any method or technology for storage of information, such as computer readable instructions, data structures, program modules, or other data.

Examples of storage media include random access memory (RAM), read only memory (ROM), magnetic storage (e.g., disks, tapes, devices), optical storage (e.g., disks, devices), CDs, DVDs, flash memory, phase change memory, or any other suitable storage media. Certain implementations may involve either or both virtual memory and non-virtual memory. In no case do storage media consist of a propagated signal. In addition to storage media, in some implementations storage system 403 may also include communication media over which software 402 may be communicated internally or externally.

Storage system 403 may be implemented as a single storage device but may also be implemented across multiple storage devices or sub-systems co-located or distributed relative to each other. Storage system 403 may include additional elements, such as a controller, capable of communicating with processing system 401.

Software 402 may be implemented in program instructions and among other functions may, when executed by system 400 in general or processing system 401 in particular, direct system 400 or processing system 401 to operate as described herein for ensuring the integrity of enterprise asset management data. Software 402 may provide program instructions that implement queue application, enterprise asset management data store, temporary repository, and workflow roles and management component. Software 402 may implement on system 400 components, programs, agents, or layers that implement in computer or machine-readable processing instructions the methods described herein for ensuring the integrity of enterprise asset management data.

Software 402 may also include additional processes, programs, or components, such as operating system software or other application software. Software 402 may also include firmware or some other form of machine-readable processing instructions executable by processing system 401.

In general, software 402 may, when loaded into processing system 401 and executed, transform system 400 overall from a general-purpose computing system into a special-purpose computing system customized to ensure the integrity of enterprise asset management data. Indeed, encoding software 402 on storage system 403 may transform the physical structure of storage system 403. The specific transformation of the physical structure may depend on various factors in different implementations of this description. Examples of such factors may include, but are not limited to, the technology used to implement the storage media of storage system 403 and whether the computer-readable storage media are characterized as primary or secondary storage.

System 400 may represent any computing system on which software 402 may be staged and from where software 402 may be distributed, transported, downloaded, or otherwise provided to yet another computing system for deployment and execution, or yet additional distribution.

It should be noted that many elements of system 400 may be included in a system-on-a-chip (SoC) device. These elements may include, but are not limited to, the processing system 401, a communications interface 404, and even elements of the storage system 403 and software 402.

In embodiments where the system 400 includes multiple computing devices, one or more communications networks may be used to facilitate communication among the computing devices. For example, the one or more communications networks can include a local, wide area, or ad hoc network that facilitates communication among the computing devices. One or more direct communication links can be included between the computing devices. In addition, in some cases, the computing devices can be installed at geographically distributed locations. In other cases, the multiple computing devices can be installed at a single geographic location, such as a server farm or an office.

A communication interface 404 may be included, providing communication connections and devices that allow for communication between system 400 and other computing systems (not shown) over a communication network or collection of networks (not shown) or the air. Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned communication media, network, connections, and devices are well known and need not be discussed at length here.

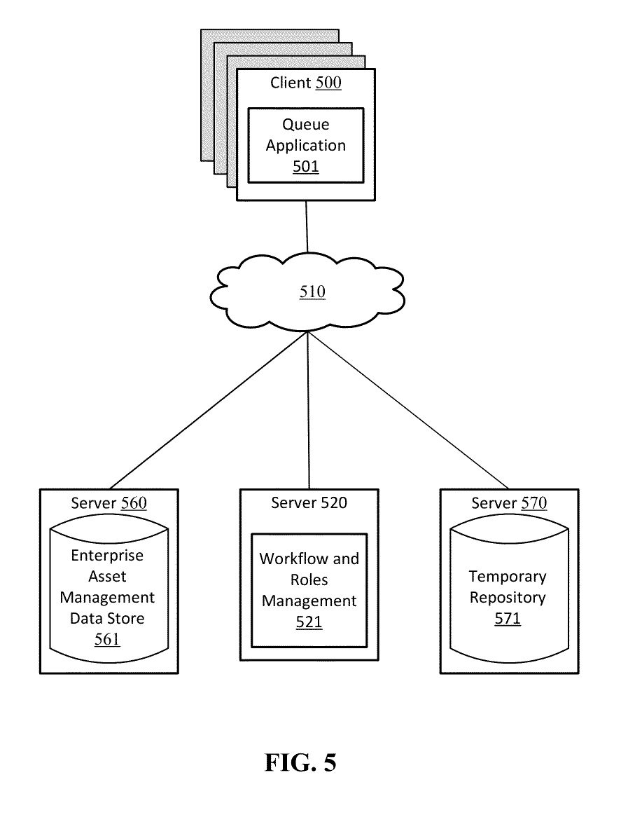

FIG. 5 illustrates an example system architecture in which an implementation of techniques and systems for ensuring the integrity of enterprise asset management data may be carried out. In the example illustrated in FIG. 5, a queue application 501 can be implemented on a client device 500, which may be a particular instantiation of a system 400 as described with respect to FIG. 4, and may be or include computing systems such as a laptop, desktop, tablet, mobile phone, and the like. Many queue applications may be present in a given environment (represented by the gray shadow boxes behind 500). Each queue application 501 may represent a work queue or instance of a work queue.

Communications and interchanges of data between components in the environment may take place over network 510. The network 510 can include, but is not limited to, a cellular network (e.g., wireless phone), a point-to-point dial up connection, a satellite network, the Internet, a local area network (LAN), a wide area network (WAN), a WiFi network, an ad hoc network, an intranet, an extranet, or a combination thereof. The network may include one or more connected networks (e.g., a multi-network environment) including public networks, such as the Internet, and/or private networks such as a secure enterprise private network.

A workflow and roles management component 521, appropriate for routing update requests between queues, designing workflows between work queues, and managing data with respect to workflow activities, may be implemented as software or hardware (or a combination thereof) on server 520, which also may be an instantiation of system 400.

Enterprise asset management data store 561, which stores enterprise asset management entity types and entities, may be implemented as software or hardware (or a combination thereof) on server 560, which also may be an instantiation of system 400.

Enterprise asset management data store may be implemented, for example, as a relational database or tables and objects thereof. A relational database maybe implemented on a relational database management system, such as SAP® or Microsoft SQL Server®.

Temporary repository 571, which stores enterprise asset management data element changes temporarily during the update request workflow processing, may be implemented as software or hardware (or a combination thereof) on server 570, which also may be an instantiation of system 400. Temporary repository 571 may be a separate component from the enterprise asset management data store 561, or may be hosted by same.

FIG. 5 shows system components operative on separate devices 500, 520, 560, and 570. It should be noted, however, that any number of and even all of the software components described above as queue application 501, workflow and roles management 521, enterprise asset management data store 561, and temporary repository 571 need not be run on separate devices, and may indeed be run on the same device.

Alternatively, or in addition, the functionality, methods and processes described herein can be implemented, at least in part, by one or more hardware modules (or logic components). For example, the hardware modules can include, but are not limited to, application-specific integrated circuit (ASIC) chips, field programmable gate arrays (FPGAs), system-on-a-chip (SoC) systems, complex programmable logic devices (CPLDs) and other programmable logic devices now known or later developed. When the hardware modules are activated, the hardware modules perform the functionality, methods and processes included within the hardware modules.

Certain aspects of the invention provide the following non-limiting embodiments:

### EXAMPLE 1

A system for ensuring the integrity of enterprise asset management data, the system comprising: one or more computer readable storage media; at least one enterprise asset management data store contained on at least one of the one or more computer readable storage media, the at least one enterprise asset management data store comprising one or more enterprise asset management data entities of an entity type selected from the group consisting of an equipment entity type, a functional location entity type, an MRO bill of material entity type, and a work center entity type; program instructions stored on the one or more computer readable storage media that, when executed by a processing system, direct the processing system to: receive, from a requester work queue having a requester role, an update request for a change to a particular one or more enterprise asset data elements, wherein the change to the particular one or more enterprise asset data elements is stored in a temporary data repository; route the update request to one or more specialist work queue, each specialist work queue having a specialist role and a first set of update validation rules for validating the update request, and when the update request violates a subset of the first set of update validation rules, modify the update request or return the update request to the requester work queue, and when the update request conforms with all of the first set of update validation rules, route the update request to one or more steward work queue; receive the update request at the one or more steward work queue, each steward work queue having a steward role and a second set of update validation rules for validating the update request, and when the update request violates a subset of the second set of update validation rules, return the update request to a prior work queue, and when the update request conforms with all of the second set of update validation rules, route the update request to a backend processing work queue; and receive the update request at the backend processing work queue, the backend processing work queue having a backend processing authorization role, and update the at least one enterprise asset management data store with the change to the particular one or more enterprise asset data elements stored in the temporary data repository.

### EXAMPLE 2

The system of example 1, wherein a particular enterprise asset data entity of the equipment entity type comprises data describing a single physical object that is maintained as an autonomous unit.

### EXAMPLE 3

The system of any of examples 1-2, wherein a particular enterprise asset data entity of the functional location entity type comprises data describing a place at which a maintenance task is performed, wherein the place is described according to functional, process-oriented, or spatial criteria.

### EXAMPLE 4

The system of any of examples 1-3, wherein a particular enterprise asset data entity of the MRO bill of material entity type comprises data describing a quantity, a unit of measure, and a description of one or more components that make up a physical object.

### EXAMPLE 5

The system of any of examples 1-4, wherein a particular enterprise asset data entity of the work center entity type comprises data describing where and when an activity is performed.

### EXAMPLE 6

The system of any of examples 1-5, wherein the first set of update validation rules and the second set of update validation rules are comprised of rules associated with one or more of the entity types.

### EXAMPLE 7

The system of any of examples 1-6, wherein the update request for the change to the particular one or more enterprise asset management data elements comprises one or more of: adding a new entity, modifying an attribute of an existing entity, and deleting a particular entity.

### EXAMPLE 8

The system of any of examples 1-7, wherein the routing to a plurality of specialist work queues is performed in series or in parallel.

### EXAMPLE 9

The system of any of examples 1-8, wherein the routing to a plurality of steward work queues is performed in series or in parallel.

### EXAMPLE 10

The system of any of examples 1-9, further comprising program instructions stored on the one or more computer readable storage media that, when executed by the processing system: render an interface for defining a unique work queue routing workflow; and store the unique work queue routing workflow on the at least one enterprise asset management data store.

### EXAMPLE 11

A method for ensuring the integrity of enterprise asset management data within a data store, the method comprising: receiving, from a requester work queue having a requester role, an update request for a change to a particular one or more enterprise asset data elements of one or more enterprise asset management data entities stored on the data store, wherein the change to the particular one or more enterprise asset data elements is stored in a temporary data repository, wherein the one or more enterprise asset management data entities have an entity type selected from the group consisting of an equipment entity type, a functional location entity type, an MRO bill of material entity type, and a work center entity type; routing the update request to one or more specialist work queue, each specialist work queue having a specialist role and a first set of update validation rules for validating the update request, and when the update request violates a subset of the first set of update validation rules, modifying the update request or returning the update request to the requester work queue, and when the update request conforms with all of the first set of update validation rules, routing the update request to one or more steward work queue; receiving the update request at the one or more steward work queue, each steward work queue having a steward role and a second set of update validation rules for validating the update request, and when the update request violates a subset of the second set of update validation rules, returning the update request to a prior work queue, and when the update request conforms with all of the second set of update validation rules, routing the update request to a backend processing work queue; and receiving the update request at the backend processing work queue, the backend processing work queue having a backend processing authorization role, and updating the data store with the change to the particular one or more enterprise asset data elements stored in the temporary data repository.

### EXAMPLE 12

The method of example 11, wherein a particular enterprise asset data entity of the equipment entity type comprises data describing a single physical object that is maintained as an autonomous unit.

### EXAMPLE 13

The method of any of examples 11-12, wherein a particular enterprise asset data entity of the functional location entity type comprises data describing a place at which a maintenance task is performed, wherein the place is described according to functional, process-oriented, or spatial criteria.

### EXAMPLE 14

The method of any of examples 11-13, wherein a particular enterprise asset data entity of the MRO bill of material entity type comprises data describing a quantity, a unit of measure, and a description of one or more components that make up a physical object.

### EXAMPLE 15

The method of any of examples 11-14, wherein a particular enterprise asset data entity of the work center entity type comprises data describing where and when an activity is performed.

### EXAMPLE 16

The method of any of examples 11-15, wherein the first set of update validation rules and the second set of update validation rules are comprised of rules associated with one or more of the entity types.

### EXAMPLE 17

The method of any of examples 11-16, wherein the update request for the change to the particular one or more enterprise asset management data elements comprises one or more of: adding a new entity, modifying an attribute of an existing entity, and deleting a particular entity.

### EXAMPLE 18

The method of any of examples 11-17, wherein the routing to a plurality of specialist work queues is performed in series or in parallel.

### EXAMPLE 19

The method of any of examples 11-18, wherein the routing to a plurality of steward work queues is performed in series or in parallel.

### EXAMPLE 20

The method of any of examples 11-19, further comprising: rendering an interface for defining a unique work queue routing workflow; and storing the unique work queue routing workflow on the data store.

### EXAMPLE 21

One or more computer readable storage media having instructions stored theron, that when executed by a processing system, direct the processing system to perform the method according to any of examples 1-20.

All patents, patent applications, provisional applications, and publications referred to or cited herein are incorporated by reference in their entirety, including all figures and tables, to the extent they are not inconsistent with the explicit teachings of this specification.

It should be understood that the examples and embodiments described herein are for illustrative purposes only and that various modifications or changes in light thereof will be suggested to persons skilled in the art and are to be included within the spirit and purview of this application and the scope of the appended claims. In addition, any elements or limitations of any invention or embodiment thereof disclosed herein can be combined with any and/or all other elements or limitations (individually or in any combination) or any other invention or embodiment thereof disclosed herein, and all such combinations are contemplated with the scope of the invention without limitation thereto.

TABLE 1A
Equipment Entity

| Attribute | Description |
|---|---|
| EQUI | Equipment Number |
| ABCK_EILO | ABC indicator for technical object |
| ANL2_EILO | Asset Subnumber |
| ANL1_EILO | Main Asset Number |
| AUFN_EILO | Settlement order |
| BEBE_EILO | Plant section |
| BUKR_EILO | Company Code |
| BCHR_EQUI | Batch Number |
| CHAR_EQUI | Batch Number |
| DATBI_EIL | Valid To Date |
| DAUF_EILO | Standing order number |
| EQLFNEQUI | Consecutive numbering of |
| | EquipUsagePeriods on same day |
| GSBE_EILO | Business Area |
| INGR_EEQZ | Planner Group for Customer Service and |
| | Plant Maintenance |
| JOBJN_EQI | Object number |
| KOKR_EILO | Controlling Area |
| KOST_EILO | Cost Center |
| KUNNREQUI | Customer Number |
| LAGER_EQI | Storage Location |
| EQASP | Language Key (Technical) |
| LBBSA_EQI | Stock Type of Goods Movement (Primary |
| | Posting) |
| ELIEF | Account Number of Vendor or Creditor |
| MAT_EQU | Material Number |
| MGAN_EEQZ | Master Warranty |
| NATI_EILO | Version ID for International Addresses |
| OBJI_EEQZ | Object ID of the resource |
| OBJI_EILO | Object ID of the resource |
| OBJT_EQUI | Object types of the CIM resource |
| PPLA_EEQZ | Maintenance Planning Plant |
| PROI_EILO | Work Breakdown Structure Element (WBS |
| | Element) |
| RBNR_EEQZ | Catalog Profile |
| SOBKS_EQI | Special Stock Indicator |
| SPAR_EILO | Division |
| SPA_EQUI | Division |
| STOR_EILO | Location of maintenance object |
| SUBM_EEQZ | Material Number |
| SWER_EILO | Maintenance plant |
| TJO2T_EQI | System status |
| TPLN_EILO | Functional Location |
| VKBU_EILO | Sales Office |
| VKGR_EILO | Sales Group |
| VKOR_EILO | Sales Organization |
| VTWE_EILO | Distribution Channel |
| WERK_EQUI | Plant |
| ACT_AA | Change Equipment Master when Changing |
| | Asset |
| ANSDT | Acquisition date |
| ANSWT | Acquisition Value |
| APLKZ | Indicator: Task List Exists |
| ARBP_EEQZ | Main Work Center |
| ARBP_EILO | Main Work Center |
| AULDT | First delivery date of the equipment |
| BAUJJ | Year of construction |
| BAUMM_EQI | Month of construction |
| BEGRU | Technical object authorization group |
| BLDA_EEQZ | Document Date in Document |
| BRGEW | Gross Weight |
| BSTVP | Stock Check for Serial Numbers |
| BUKRS_EQZ | Company Code |
| CUOBJ | Configuration (internal object number) |
| DATA_EEQZ | Valid-From Date |
| DATB_EEQZ | Valid To Date |
| DATLWB | Date of Last Goods Movement |
| EMATN | Material Number Corresponding to |
| | Manufacturer Part Number |
| EQART_EQU | Technical Object Type |
| EQEXT_ACT | Backpack Table/IS DFPS/LMEQEXT |
| | Active |
| EQFN_EILO | Sort field |
| EQLB_DUTY | Logbook Duty |
| EQLB_HIDE | Hide Logbook Display |
| EQLF_EEQZ | Consecutive numbering of |
| | EquipUsagePeriods on same day |
| EQSNR | EQSE Number |
| EQTYP | Equipment category |
| EQUI_SNTY | Shift Note Type |
| EQUI_SRTY | Shift Report Type |
| EQZN_EEQZ | Number of next EquipUsagePeriod on same |
| | day |
| FLAG_DELE | Flag for Deletion of an Equipment record |
| GERNR | Serial Number |
| GEWEI | Unit of weight |
| GROES_EQU | Size/dimension |
| GWLDT | Guarantee date |
| GWLDV | Warranty date for Sales and Distribution |
| GWLEN | Date on which the warranty ends |
| HEQN_EEQZ | Equipment position at InstallLoc (Superior |
| | Equip./FunctLoc) |
| HEQU_EEQZ | Superordinate Equipment |
| HERLD | Country of manufacture |
| HERST | Manufacturer Name |
| HZEIN | Manufacturer drawing number |
| IBLN_EEQZ | Physical Inventory Document |
| INBDT | Start-up Date of the Technical Object |
| INVNR | Inventory number |
| IUID_TYPE | Structure Type of UII |
| KDAUF | Sales Order Number |
| KDPOS | Item Number in Sales Order |
| KMATN | Configurable Material |
| KRFKZ | Referenced Configuration |
| KUN1_EEQZ | Customer number |
| KUN2_EEQZ | End customer number |
| KUNDE | Customer to Whom Serial Number was |
| | Delivered |
| KUND_EEQZ | Operator |
| LIZN_EEQZ | Equipment license number |
| LVORM_EQI | Flag Equipment for Deletion at Client Level |
| LVOR_EEQZ | Flag Equipment for Deletion (EQUZ) |
| MAPA_EEQZ | Manufacturer part number |
| MATKL | Material Group |
| MEAS_PT | Measuring Point |
| MSGR_EILO | Room |
| OWNE_EILO | Object reference indicator |
| PS_PSP_PN | Work Breakdown Structure Element (Stock |
| | Segm) |
| REVLLV | Revision Level |
| SERGE | Manufacturer serial number |
| SERNR | Serial Number |
| STTXT | Description of maintenance status |
| S_CC | Configuration Control Data |
| S_ELSE | Indicator: Other Data Active |
| S_EQBS | EQSI Exists |
| S_EQUI | Equipment data exists |
| S_FHM | Equip. category relevant to production |
| | resources and tools |
| S_FLEET | Indicator: Fleet object active |
| S_ISU | IS-U data |
| S_KONFI | Configuration supported |
| S_SALE | Sales equipment |
| S_SERIAL | Serial data when maintaining equipment |
| TECH_EEQZ | Parameter Variant/Standard Variant |
| TIDN_EEQZ | Technical identification number |
| TIME_EEQZ | Equipment usage period time stamp |
| TXT04 | Individual status of an object (short form) |
| TXT30 | Object status |
| TYPBZ | Manufacturer model number |
| UII | Unique Item Identifier |
| UII_PLANT | Plant Responsible for Unique Item |
| | Identifier |
| WAERS | Currency Key |
| WARPL | Maintenance Plan |
| WDBWT | Equipment replacement value |
| WERGW_EQI | Plant associated with main work center |

TABLE 1B
Equipment Entity Business Rules

| | | Comment |
|---|---|---|
| Rule Control | Business Rule | (Message |
| Number | Description | Displayed) |
| EAM-EQUI-001 | Equipment Category is a | Equipment Category |
| | required field. | is a required field |
| EAM-EQUI-002 | Default Valid To Date to | No message displayed |
| | 31 Dec. 9999. | |
| EAM-EQUI-003 | Default Valid From Date to | No message displayed |
| | current date. | |
| EAM-EQUI-004 | Valid From Date can't be a | Valid From Date can't |
| | future date | be a future date |
| EAM-EQUI-005 | Company Code should be | No message displayed |
| | automatically derived when | |
| | the Maintenance Plant is | |
| | populated. | |
| EAM-EQUI-006 | Controlling Area should be | No message displayed |
| | read-only and automatically | |
| | derived when the | |
| | Maintenance Plant or | |
| | Company Code is populated. | |
| EAM-EQUI-007 | Planning Plant should be | No message displayed |
| | automatically derived when | |
| | the Maintenance Plant is | |
| | populated. | |
| EAM-EQUI-008 | Work Center can't exist | Maintenance Plant |
| | without Maintenance Plant. | is required for Work |
| | | Center |
| EAM-EQUI-009 | Work Center must exist in | Work Center (EQUI- |
| | the Maintenance Plant. | ARBPL) does not exist |
| | | in Maintenance Plant |
| | | (EQUI-SWERK) |
| EAM-EQUI-010 | Only allow Class that | Class (EQUICLASS- |
| | belongs to Class Type 002 | CLASS) does not |
| | (Equipment). | belong to Class Type |
| | | 002 (Equipment) |
| EAM-EQUI-011 | Class Type should be derived | No message displayed |
| | from Class entered. | |
| EAM-EQUI-012 | If both Functional Location | Superordinate |
| | and Superordinate Equipment | Equipment |
| | are entered, validate that the | is not installed at |
| | Superordinate Equipment is | Functional Location |
| | installed at the Functional | |
| | Location | |
| EAM-EQUI-013 | Superordinate Equipment | Different plants not |
| | must be maintained at same | permitted within an |
| | plant as Equipment | equipment hierarchy |
| EAM-EQUI-014 | Functional Location must be | Different plants not |
| | at same plant as Equipment | permitted for |
| | | installation/ |
| | | dismantling |
| EAM-EQUI-015 | Change Company Code and | Company code in |
| | Controlling Area entered to | equipment to be |
| | values from Superordinate | installed was |
| | Equipment if different. | changed from (EQUI- |
| | | BUKRS) to (LOA- |
| | | BUKRS) |
| EAM-EQUI-016 | If both Functional Location | Functional Location |
| | and Superordinate | (EQUI-TPLNR) was |
| | Equipment are entered, | changed to |
| | change the Functional | (ILOA_TPLNR) |
| | Location to one | |
| | Superordinate Equipment is | |
| | installed at if different. | |
| EAM-EQUI-017 | Validate external Equipment | Equipment number |
| | Number against external | (EQUI-EQUNR) is not |
| | number interval. | between (NRIV- |
| | | FROMNUMBER) and |
| | | (NRIV-TONUMBER) |
| EAM-EQUI-018 | Default Location Valid To | No message displayed |
| | Date to 31 Dec. 9999 if both | |
| | Cost Center and Controlling | |
| | Area are populated. | |
| EAM-EQUI-019 | Work Center Plant should be | No message displayed |
| | automatically derived when | |
| | the Main Work Center is | |
| | populated. | |
| EAM-EQUI-020 | Work Center Plant can't be | Main Work Center |
| | entered without entering | required for Work |
| | Main Work Center. | Center Plant |
| EAM-EQUI-021 | Serial Number can't exist | Material Number |
| | without Material Number. | required for |
| | | Serial Number |
| EAM-EQUI-022 | Serial Number must be | Serial Number (EQUI- |
| | unique within Material | SERNR) already exists |
| | Number. | for Material (EQUI- |
| | | MAT_EQU) |
| EAM-EQUI-023 | Configurable Material must | Material (EQUI- |
| | be defined as configurable. | KMATN) is not a |
| | | configurable material |

TABLE 2A
Functional Location Entity

| Attribute | Description |
|---|---|
| FUNCLOC | Functional Location |
| ABCKZFLOC | ABC indicator for technical object |
| ANLA_FL | Asset Subnumber |
| ANLN1_FL | Main Asset Number |
| ARBPLFLOC | Work center |
| AUFN_FLOC | Settlement order |
| BEBER_FL | Plant section |
| BUKRSFLOC | Company Code |
| DATBI_FLO | Valid To Date |
| DAUF_FLOC | Standing order number |
| EDIT_FLOC | Functional location edit mask |
| EQLF_FLOC | Consecutive numbering of |
| | EquipUsagePeriods on same day |
| EQUI_FLOC | Technical Key |
| GEWRKFLOC | Main work center for maintenance tasks |
| GSBE_FLOC | Business Area |
| INGR_FLOC | Planner Group for Customer Service and |
| | Plant Maintenance |
| JOBJN_FL | Object number |
| KOKR_FLOC | Controlling Area |
| KOST_FLOC | Cost Center |
| OBJIDFLOC | Object ID of the resource |
| OBJTYFLOC | Object types of the CIM resource |
| PAVW_FLOC | Partner Function |
| PLNT_FLOC | Maintenance Planning Plant |
| PROI_FLOC | Work Breakdown Structure Element (WBS |
| | Element) |
| RBNR_FLOC | Catalog Profile |
| STOR_FLOC | Location of maintenance object |
| STUF_FLOC | Functional Location Hierarchy Levels |
| SUBMTIFLO | Material Number |
| SWERK_FL | Maintenance plant |
| TPLKZ_FLC | Functional location structure indicator |
| WERGWFLOC | Plant associated with main work center |
| ANSDT | Acquisition date |
| ANSWT | Acquisition Value |
| BAUJJ | Year of construction |
| BAUMM | Month of construction |
| BEGRU | Technical object authorization group |
| BRGEW | Gross Weight |
| CR_KTEXT | Short description |
| EINZL | Single equipment installation at functional |
| | location |
| EQART | Type of Technical Object |
| EQFNR | Sort field |
| FING | Person Responsible for Company Area |
| FLTYP | Functional location category |
| GEWEI | Unit of weight |
| GROES | Size/dimensions |
| HERLD | Country of manufacture |
| HERST | Manufacturer of asset |
| IEQUI | Installation of equipment allowed at the |
| | functional location |
| IFLOT_SRT | Shift Report Type for Object |
| INBDT | First start-up date |
| INVNR | Inventory number |
| I_TEXT | Description of the Planner Group |
| KOST_TEXT | General Name |
| KTEXT | Text, 40 Characters Long |
| LVORM | Flag for Deletion |
| MAPAR | Manufacturer part number |
| MSGRP | Room |
| ORT01 | City |
| SERGE | Manufacturer serial number |
| STATTEXT | Display lines for system status |
| TELE | Phone number of person responsible for |
| | company area |
| TXT50 | Asset description |
| TYPBZ | Manufacturer model number |
| WAERS | Currency Key |

TABLE 2B
Functional Location Business Rules

| | | Comment |
|---|---|---|
| Rule Control | Business Rule | (Message |
| Number | Description | Displayed) |
| EAM-FLOC-001 | Acquisition value should | Maintain the currency |
| | not be entered without | for the acquisition |
| | a description | value |
| EAM-FLOC-002 | Planner group should not | Planning plant does not |
| | be entered without a | support MaintPlanGrp |
| | Maintenance Planning plant | “Planner Group” |
| EAM-FLOC-003 | Cost Center should not | A controlling area has |
| | be entered without a | not yet been defined |
| | Controlling area | |
| EAM-FLOC-004 | Plant and Location should | Plant “Plant” does not |
| | be on Sync | support location |
| | | “Location” |
| EAM-FLOC-005 | Location should not be | Plant “Plant” does not |
| | entered without a Plant | support location |
| | | “Location” |
| EAM-FLOC-006 | Work Center should not be | Enter the Plant for the |
| | entered without a Plant | main work center |
| EAM-FLOC-007 | Plant and Plant Section | Maintenance plant |
| | should be in Sync | “Plant” does not |
| | | support plant section |
| | | “Plant Section” |
| EAM-FLOC-008 | Plant Section should not be | Maintenance plant |
| | entered without a Plant | “Plant” does not |
| | | support plant section |
| | | “Plant Section” |

TABLE 3A
MRO Bill of Materials (BOM) Entity

| Attribute | Description |
|---|---|
| MATNR | Material |
| STALT | Alternative BOM |
| STLAN | BOM Usage |
| WERKS | Plant |
| ALEIND | ALE Indicator |
| AUTHGROUP | Authorization Group |
| BASEQTY | Base Quantity |
| BASEUOM | Base Unit Of Measure |
| BOMSTATUS | BOM Status |
| CADIND | CAD Indicator |
| DELFLG | Deletion Flag |
| DELIND | Deletion Indicator |
| LABOFC | Lab Office |
| LNGTXT | BOM Long Text |
| PMBOMGRP | BOM group |
| PMBOMTECH | Technical type |
| SIZDIM | Size Dimension |
| STKTX | Alternate Text |
| STNUM | Bill of Material |
| VALIDFROM | Valid From Date |
| VALIDTODA | Valid To Date |

TABLE 3B
MRO Bill of Materials Item

| Attribute | Description |
|---|---|
| BOMITMPOS | BOM Item Number |
| MATNR | Material Number |
| STALT | Alternative BOM |
| STLAN | BOM Usage |
| WERKS | Plant |
| ASSELCND | Indicator: classification as selection |
| | condition |
| BOMDOCITM | Document number |
| BOMITMCLS | Class Type |
| BOMITMDKR | Document Type |
| BOMITMDTL | Document Part |
| BOMITMDVR | Document Version |
| COMPDESC | Material Description (Short Text) |
| COMPNET | Indicator: Net scrap |
| COMPSCRAP | Component scrap in percent |
| COPROD | Indicator: co-product |
| COSTGRELV | Indicator for relevancy to costing |
| EKGRP | Purchasing Group |
| EKORG | Purchasing Organization |
| ERSKZ | Indicator: spare part |
| EXPLTYP | Explosion type |
| FIXEDQTY | Quantity is Fixed |
| ITEMID | Item ID |
| ITMASSIND | Indicator: assembly |
| ITMBULMAT | Indicator: Bulk Material |
| ITMCATREF | Item Category (Bill of Material) |
| ITMCOMP | BOM component |
| ITMLNGTXT | BOM Item Long Text |
| ITMOBJIND | Indicator: object dependencies exist |
| ITMQTY | Component quantity |
| ITMSUBIND | Indicator: sub-items exist |
| ITMUOM | Component unit of measure |
| ITM_KTOPL | Chart of Accounts |
| ITM_SAKTO | Cost Element |
| ITSOBBOM | Special procurement type for BOM item |
| LEADTIMEO | Lead-time offset |
| LGTXTIND | Indicator: long text exists for item |
| LIFZT | Delivery Time (days) |
| MATKL | Material Group |
| MATPROIND | Material Provision Indicator |
| OPERLTOFS | Lead-time offset for operation |
| OPERLTUNI | Unit for lead-time offset for operation |
| OPERSCRAP | Operation scrap |
| PEINH | Price Unit |
| PHANTOMIN | Phantom item indicator |
| PMASSMBLY | PM assembly indicator |
| POTX1 | BOM Item Text (Line 1) |
| POTX2 | BOM item text (line 2) |
| PREIS | Price |
| RECURALLO | Indicator: recursiveness allowed |
| SCHKZ | Bulk Material Indicator in Material |
| | Master |
| SORTSTRIN | Sort String |
| STLKN | BOM item node number |
| STPOZ | Internal counter |
| VALIDFRM | Valid-From Date |
| VALIDTO | Valid-to date |
| VENDOR | Vendor |
| VERTLBOM | Distribution key for component |
| | consumption |
| WAERS | Currency |
| WEBAZ | GR Processing Time |

TABLE 3C
MRO Bill of Material Business Rules

| | | Comment |
|---|---|---|
| Rule Control | Business Rule | (Message |
| Number | Description | Displayed) |
| EAM-MROBOM-001 | Derivation of Header | No Message |
| | Material description from | |
| | table MAKT-MAKTX | |
| EAM-MROBOM-002 | Base quantity field to | No Message |
| | be defaulted from table | |
| | TCS03_V - BMENG | |
| EAM-MROBOM-003 | Header Material UOM to | No Message |
| | be defaulted from Material | |
| | master Base UOM, from | |
| | table MARA - MEINS | |
| EAM-MROBOM-004 | Valid from Date at header | No Message |
| | level to system date | |
| | (current date) | |
| EAM-MROBOM-005 | Default valid to date to | No Message |
| | Dec. 31, 9999 | |
| EAM-MROBOM-006 | Bom Header status from | No Message |
| | TCS03_V - STLST | |
| EAM-MROBOM-007 | Lab Office at header | No Message |
| | default from Material | |
| | master table MARA - | |
| | LABOR | |
| EAM-MROBOM-008 | Size dimensions derive | No Message |
| | from Material master | |
| | table MARA - GROES | |
| EAM-MROBOM-009 | Derive Component | No Message |
| | description from item | |
| | material master table | |
| | MAKT - MAKTX | |
| EAM-MROBOM-010 | Derive UOM from item | No Message |
| | material master | |
| | MARA- MEINS | |
| EAM-MROBOM-011 | Derive Valid from Date | No Message |
| | at item level to system | |
| | date (current date) | |
| EAM-MROBOM-012 | Default valid to date to | No Message |
| | Dec. 31, 9999 | |
| EAM-MROBOM-013 | Derive from BOM Usage | No Message |
| | “4” configuration | |
| EAM-MROBOM-014 | Derive from BOM Usage | No Message |
| | “4” configuration from | |
| | table T416V-SANKA | |
| EAM-MROBOM-015 | Derive Phantom item | No Message |
| | from Special procurement | |
| | key table T460A-DUMPS | |
| | and if Explosion type | |
| | entered then, table | |
| | T414 - KZDUM. | |
| EAM-MROBOM-016 | When component is | Material XX |
| | entered at item level, | not maintained |
| | check for existence of | in plant |
| | component in same header | XXXX |
| | plant exist. | |
| EAM-MROBOM-017 | If Operation Scrap % is | Operation scrap |
| | initial, then if Net | can only be |
| | Indicator is not set then | maintained |
| | throw error message. | in connection |
| | | with net |
| | | indicator |
| EAM-MROBOM-018 | If Component material and | BOM is |
| | header material are the | recursive |
| | same and Recursive Allow | |
| | is initial, then throw | |
| | the Error Message | |
| EAM-MROBOM-019 | Cannot have both Cost | Bulk material |
| | Relevant and Bulk | not allowed |
| | Material indicator set. | for items |
| | | relevant to |
| | | costing |
| EAM-MROBOM-020 | Only Alternative BOM | No Message |
| | ‘1’ is supported | |
| | with the standard | |
| | APIs and IDoc Messaging. | |
| | Derive default value of ‘1’ | |
| EAM-MROBOM-021 | Derive Bulk Material | No Message |
| | indicator from material | |
| | master for component items | |
| | from table MARC- SCHGT | |
| EAM-MROBOM-022 | Derive Phantom Item | No Message |
| | Indicator based on | |
| | Explosion Type/Special | |
| | procurement key. | |
| EAM-MROBOM-023 | ITEM CATEGORY D | 1. Do not enter |
| | 1. Component cannot be | material for item |
| | entered | category D. |
| | 2. Document, Document type, | Check item |
| | Document part, Doc version | position xxxx |
| | are mandatory | 2. Please enter |
| | 3. UOM Defaulted form table | complete |
| | TCS03-BMEIN and greyed | document key |
| | out - Known issue its | |
| | editable now. | |
| | 4. Quantity defaulted to 1 | |
| | and editable | |
| | 5. Component description is | |
| | derived from Document | |
| | # description table DRAT- | |
| | DKTXT and greyed out | |
| | 6. Optional open fields | |
| | available for input: Fixed | |
| | qty and all other | |
| | fields greyed out. | |
| EAM-MROBOM-024 | ITEM CATEGORY T | 1. Do not enter |
| | 1. UOM Defaulted form | material for |
| | table TCS03-BMEIN | item category T. |
| | and editable | Check item |
| | 2. Quantity defaulted to 1 | position xxxx |
| | and editable | |
| | 3. Fixed quantity checkbox | |
| | activated and editable | |
| | 4. item text mandatory | |
| EAM-MROBOM-025 | ITEM CATEGORY I | No Message |
| | 1. Component Mandatory | |
| | 2. UOM derived from | |
| | component and editable | |
| | 3. PM Assembly checkbox | |
| | activated and editable | |
| | 4. Optional fields available | |
| | for input: Recursive allowed, | |
| | explosion type, spl proc key, | |
| | spare parts indicator, costing | |
| | relevancy indicator | |
| EAM-MROBOM-026 | ITEM CATEGORY N - No | 1. Please enter |
| | Component | all price data |
| | 1. UOM Defaulted form table | |
| | TCS03-BMEIN and editable | |
| | 2. Costing relevancy | |
| | defaulted from T416V- | |
| | SANKA and editable | |
| | 3. Currency defaulted to | |
| | company code assigned to | |
| | plant and editable | |
| | 4. Purchasing organization | |
| | derive from plant assigned | |
| | to it and editable | |
| | 5. Price unit defaulted to | |
| | 1 and editable | |
| | 6. Item text mandatory, | |
| | item price, purchasing | |
| | group, material group | |
| | mandatory fields | |
| | 7. Optional fields available | |
| | for input: fixed qty, | |
| | operation scrap in %, net | |
| | id, component scrap, | |
| | recursive allowed, lead time | |
| | offset, OP lt offset, | |
| | distribution key, explosion | |
| | type, spare part indicator, | |
| | mat provision indicator, | |
| | Bulk Material, vendor, cost | |
| | element, delivery time | |
| | days, gr processing time | |
| EAM-MROBOM-027 | ITEM CATEGORY N - | 1. Please enter |
| | With Component Material | all price data |
| | 1. UOM based on the based | |
| | unit of component and | |
| | editable | |
| | 2. Costing relevancy | |
| | defaulted from T416V- | |
| | SANKA and editable | |
| | 3. Currency defaulted to | |
| | company code assigned to | |
| | plant and greyed out | |
| | 4. Derive Purch Group | |
| | from component master = | |
| | MARC- EKGRP and editable | |
| | 5. Derive Delivery Time | |
| | from component master = | |
| | MARC- PLIFZ - Derive if | |
| | populated and editable | |
| | 6. Material Grp from | |
| | component master = | |
| | MARA-MATKL - Derive if | |
| | populated and editable | |
| | 7. GR Processing Time from | |
| | component master = MARC- | |
| | WEBAZ - Derive if | |
| | populated and editable | |
| | 8. Derive Price from | |
| | component master = | |
| | MBEW-VERPR if MBEW- | |
| | VPRSV = V (moving | |
| | average) or MBEW-STPRS if | |
| | MBEW- VPRSV = S (IF | |
| | standard) - Derive if | |
| | populated - greyed out | |
| | 9. Derive price unit | |
| | from component master = | |
| | MBEW- PEINH - Derive if | |
| | populated - Defaults to 1 | |
| | and greyed out | |
| | 10 Purchasing organization | |
| | derived from org assignment | |
| | and editable | |
| | 11. Optional fields available | |
| | for input: Fixed qty, | |
| | component scrap, operation | |
| | scrap, net id, recursive | |
| | allowed, Lead time offset, | |
| | Oper Lt offset, Distribution | |
| | key, Explosion type, mat | |
| | provision indicator, Bulk | |
| | Material, spare part | |
| | indicator, PM assembly, | |
| | vendor | |

TABLE 4A
Work Center Entity

| Attribute | Description |
|---|---|
| ARBPL | Work center |
| WERKS | Plant |
| CAPTEXT | Capacity short text |
| CPLGR | CAPP planner group |
| CRLOGRP | Wage group |
| CROBJID | Object ID of the resource |
| CROBJTY | Object types of the CIM resource |
| CRORTGR | Location group |
| CRPLNAW | Application of the task list |
| CRPRVBE | Production Supply Area |
| CRQUALF | Suitability |
| CRRASCH | Setup Type Key |
| CRSTAND | Work center location |
| CRSTEUS | Control key |
| CRVERAN | Person responsible for the work center |
| FORT1 | Formula for setup time |
| FORT2 | Formula for the duration of processing |
| | time |
| FORT3 | Formula for teardown time |
| FORTN | Formula for the duration of other type of |
| | int. processing |
| KAPAR | Capacity category |
| KTSCH | Standard text key |
| KTSCH_REF | Indicator: Standard text key is referenced |
| LNGTEXT | Work Center Long text |
| LOANZ | Number of Time Tickets |
| LOANZ_REF | Indicator: Number of time tickets is |
| | referenced |
| LOART | Wage Type |
| LOART_REF | Indicator: Wage type is referenced |
| LOGRP_REF | Indicator: Wage group is referenced |
| MATYP | Machine type |
| NAME | Capacity name |
| PDEST | Printer for shop papers |
| PLANV | Key for task list usage |
| QUALF_REF | Indicator: Suitability is referenced |
| RASCH_REF | Indicator: Setup type key is referenced |
| RGEKZ | Indicator: Backflushing |
| RSANZ | Number of confirmation slips |
| RSANZ_REF | Indicator: Number of confirmation slips is |
| | referenced |
| RUZUS | Key: rounding and additional values |
| SORTB | Sort string |
| STEUS_REF | Indicator: Control key is referenced |
| SUBSYS | Subsystem Identifier for QM Subsystem |
| | Interface |
| TXTMI | Description (medium text) |
| TXT_01 | Key word for parameter ID |
| TXT_02 | Key word for parameter ID |
| TXT_03 | Key word for parameter ID |
| TXT_04 | Key word for parameter ID |
| TXT_05 | Key word for parameter ID |
| TXT_06 | Key word for parameter ID |
| VERWE | Work Center Category |
| VGARB | Unit of measure of work |
| VGDIM | Dimension of work |
| VGE01 | Unit of measure for the standard value |
| VGE02 | Unit of measure for the standard value |
| VGE03 | Unit of measure for the standard value |
| VGE04 | Unit of measure for the standard value |
| VGE05 | Unit of measure for the standard value |
| VGE06 | Unit of measure for the standard value |
| VGM01 | Rule for standard value maintenance |
| VGM02 | Rule for standard value maintenance |
| VGM03 | Rule for standard value maintenance |
| VGM04 | Rule for standard value maintenance |
| VGM05 | Rule for standard value maintenance |
| VGM06 | Rule for standard value maintenance |
| VGWTS | Standard value key |
| ZEIWM | Unit for the minimum queue time |
| ZEIWN | Unit for the standard queue time |
| ZGR01 | ID |
| ZGR02 | ID |
| ZGR03 | ID |

TABLE 4B
Work Center Entity Business Rules

| | | Comment |
|---|---|---|
| Rule Control | Business Rule | (Message |
| Number | Description | Displayed) |
| EAM-WRKCTR-001 | Validity start date- | Default to system Date |
| | System start date | and let the User change |
| EAM-WRKCTR-002 | Validity End Date- | Default to Dec. 31, 9999 |
| | Dec. 31, 9999 | and let the User change |
| EAM-WRKCTR-003 | Controlling Area | No Message Displayed |
| EAM-WRKCTR-004 | Standard Value Key | No Message Displayed |
| EAM-WRKCTR-005 | Capacity Planner | No Message Displayed |
| | Group | |
| EAM-WRKCTR-006 | Long Term Planning | No Message Displayed |
| EAM-WRKCTR-007 | Capacity Category | Capacities of Type 1 |
| | | and Type 2 are only |
| | | allowed for resources. |
| EAM-WRKCTR-008 | Formulas | No Message displayed. |
| | | Values are derived |
| | | only in display mode. |
| EAM-WRKCTR-009 | Start | No Message displayed. |
| | | Value defaulted to |
| | | 00:00:00 |
| EAM-WRKCTR-010 | Finish | No Message displayed. |
| | | Value defaulted to |
| | | 00:00:00 |
| EAM-WRKCTR-011 | Length Of breaks | No Message displayed. |
| | | Value defaulted to |
| | | 00:00:00 |
| EAM-WRKCTR-012 | Pooled Capacity | No Message displayed. |
| EAM-WRKCTR-013 | Rule for | No Message displayed. |
| | maintenance field | |
| EAM-WRKCTR-014 | UOM of Capacity | No Message Displayed. |

What is claimed is:

1. A system for ensuring the integrity of enterprise asset management data, the system comprising:
one or more computer readable storage media;
at least one enterprise asset management data store contained on at least one of the one or more computer readable storage media, the at least one enterprise asset management data store comprising one or more enterprise asset management data entities of an entity type selected from the group consisting of:
an equipment entity type;
a functional location entity type;
an MRO bill of material entity type;
a work center entity type;
program instructions stored on the one or more computer readable storage media that, when executed by a processing system, direct the processing system to:
receive, from a requester work queue having a requester role, an update request for a change to a particular one or more enterprise asset data elements, wherein the change to the particular one or more enterprise asset data elements is stored in a temporary data repository;
route the update request to one or more specialist work queue, each specialist work queue having a specialist role and a first set of update validation rules for validating the update request, and
when the update request violates a subset of the first set of update validation rules, modify the update request or return the update request to the requester work queue, and
when the update request conforms with all of the first set of update validation rules, route the update request to one or more steward work queue;
receive the update request at the one or more steward work queue, each steward work queue having a steward role and a second set of update validation rules for validating the update request, and
when the update request violates a subset of the second set of update validation rules, return the update request to a prior work queue, and
when the update request conforms with all of the second set of update validation rules, route the update request to a backend processing work queue; and
receive the update request at the backend processing work queue, the backend processing work queue having a backend processing authorization role, and update the at least one enterprise asset management data store with the change to the particular one or more enterprise asset data elements stored in the temporary data repository.

2. The system of claim 1, wherein a particular enterprise asset data entity of the equipment entity type comprises data describing a single physical object that is maintained as an autonomous unit.

3. The system of claim 1, wherein a particular enterprise asset data entity of the functional location entity type comprises data describing a place at which a maintenance task is performed, wherein the place is described according to functional, process-oriented, or spatial criteria.

4. The system of claim 1, wherein a particular enterprise asset data entity of the MRO bill of material entity type comprises data describing a quantity, a unit of measure, and a description of one or more components that make up a physical object.

5. The system of claim 1, wherein a particular enterprise asset data entity of the work center entity type comprises data describing where and when an activity is performed.

6. The system of claim 1, wherein the first set of update validation rules and the second set of update validation rules are comprised of rules associated with one or more of the entity types.

7. The system of claim 1, wherein the update request for the change to the particular one or more enterprise asset management data elements comprises one or more of: adding a new entity, modifying an attribute of an existing entity, and deleting a particular entity.

8. The system of claim 1, wherein the routing to a plurality of specialist work queues is performed in series or in parallel.

9. The system of claim 1, wherein the routing to a plurality of steward work queues is performed in series or in parallel.

10. The system of claim 1, further comprising program instructions stored on the one or more computer readable storage media that, when executed by the processing system:
render an interface for defining a unique work queue routing workflow; and
store the unique work queue routing workflow on the at least one enterprise asset management data store.

11. A method for ensuring the integrity of enterprise asset management data within a data store, the method comprising:
receiving, from a requester work queue having a requester role, an update request for a change to a particular one or more enterprise asset data elements of one or more enterprise asset management data entities stored on the data store, wherein the change to the particular one or more enterprise asset data elements is stored in a temporary data repository, wherein the one or more enterprise asset management data entities have an entity type selected from the group consisting of an equipment entity type, a functional location entity type, an MRO bill of material entity type, and a work center entity type;
routing the update request to one or more specialist work queue, each specialist work queue having a specialist role and a first set of update validation rules for validating the update request, and
when the update request violates a subset of the first set of update validation rules, modifying the update request or returning the update request to the requester work queue, and
when the update request conforms with all of the first set of update validation rules, routing the update request to one or more steward work queue;
receiving the update request at the one or more steward work queue, each steward work queue having a steward role and a second set of update validation rules for validating the update request, and
when the update request violates a subset of the second set of update validation rules, returning the update request to a prior work queue, and
when the update request conforms with all of the second set of update validation rules, routing the update request to a backend processing work queue; and
receiving the update request at the backend processing work queue, the backend processing work queue having a backend processing authorization role, and updating the data store with the change to the particular one or more enterprise asset data elements stored in the temporary data repository.

12. The method of claim 11, wherein a particular enterprise asset data entity of the equipment entity type comprises data describing a single physical object that is maintained as an autonomous unit.

13. The method of claim 11, wherein a particular enterprise asset data entity of the functional location entity type comprises data describing a place at which a maintenance task is performed, wherein the place is described according to functional, process-oriented, or spatial criteria.

14. The method of claim 11, wherein a particular enterprise asset data entity of the MRO bill of material entity type comprises data describing a quantity, a unit of measure, and a description of one or more components that make up a physical object.

15. The method of claim 11, wherein a particular enterprise asset data entity of the work center entity type comprises data describing where and when an activity is performed.

16. The method of claim 11, wherein the first set of update validation rules and the second set of update validation rules are comprised of rules associated with one or more of the entity types.

17. The method of claim 11, wherein the update request for the change to the particular one or more enterprise asset management data elements comprises one or more of: adding a new entity, modifying an attribute of an existing entity, and deleting a particular entity.

18. The method of claim 11, wherein the routing to a plurality of specialist work queues is performed in series or in parallel.

19. The method of claim 11, wherein the routing to a plurality of steward work queues is performed in series or in parallel.

20. The method of claim 11, further comprising:
rendering an interface for defining a unique work queue routing workflow; and
storing the unique work queue routing workflow on the data store.
